(19) United States
(12) Patent Application Publication
(10) Pub. No.: US 2003/0103453 A1
(43) Pub. Date: Jun. 5, 2003

(54) System and method for managing flow bandwidth utilization in a packet communication environment

(75) Inventors: Nen-Fu Huang, Hsinchu City (TW); Shi-Ming Zhao, Taipei (TW)

Correspondence Address: Ladas & Parry, 26 West 61st Street, New York, NY, 10023, US

(73) Assignee: BROADWEB CORPORATION

(21) Appl. No.: 10/003,433

(22) Filed: Dec. 5, 2001

(51) Int. Cl. H04J 1/16; H04J 3/14

(52) U.S. Cl. 370/229; 370/232; 370/412; 370/428; 370/468

(57) ABSTRACT

To manage the bandwidth of a network, a novel rate control scheme, Time-Division-Queue Rate Control Scheme (TDQ-RCS), is provided. The TDQ-RCS according to the present invention can rapidly determine departure time of an arrival packet, add the arrival packet into the time division queue to which it belongs according to the departure time, and then output the packet on schedule. All algorithms employed by the TDQ-RCS can be completed in a constant time since these algorithms are simple for the arrival packets of different sizes. Especially, the TDQ-RCS neither generates any dummy packet nor wastes any bandwidth but still can accomplish the bandwidth management. Therefore, the present invention significantly accomplishes the bandwidth management of a network without generating any dummy packet and wasting the bandwidth.

### FIELD OF INVENTION

The present invention relates to digital packet telecommunications and, in particular, to a system and method for managing utilization of the flow bandwidth in a packet communication environment.

### BACKGROUND OF INVENTION

In a network environment, the bandwidth management of the network is a key issue as the data streams flowing over the network increase. In the art of the network bandwidth management, persons skilled in the art usually control the bandwidth of each traffic stream by following the policy-based QoS Rules that users predefined. Actually, the bandwidth management of the network has several advantages, such as the protection of maximum allowable traffic streams and the decreased occurrence of end-to-end traffic congestion. In order to achieve the bandwidth management, several traditional techniques are proposed to approximate the properties of GPS (Generalized Processor Sharing) (see references 2, 6, and 13 in the Appendix for details). These techniques are WFQ (Weight Fair Queuing), WF²Q (Worst-case-Fair Weighted Fair Queuing), etc. (see references 1, 3, 4, and 12 in the Appendix for details). In fact, these traditional mechanisms are all directed to weighted-based bandwidth management algorithms, and the research community has paid a lot of attention to such algorithms. Furthermore, the WFQ has been proposed to be a basic building block for future integrated services networks by Internet Engineering Task Force (IETF). However, these techniques are so complicated that they cannot be cost-effectively implemented in high-speed network devices (see references 3 and 5 in the Appendix for details). Besides, they also cannot achieve user-friendly control manner, rate-limiting control.

To resolve the problems mentioned above, in some existing network equipments an active rate control scheme is employed (see references 7, 8, 9, 10 in the Appendix for details) in a bandwidth management device. In such an active rate control scheme, control messages are actively sent to each of end-points of the network according to the latest rate control status of each traffic stream, such that the transmission rates of all end-points can be actively slowed down or speeded up based on the sent control messages. However, the active rate control scheme inevitably generates a lot of control messages, and from the viewpoint of network utilization, these control messages are substantially all kinds of dummy packets. Therefore, the active rate control scheme still wastes a lot of bandwidth available for the network, even though this scheme can control the rate of each traffic stream very well.

### SUMMARY OF INVENTION

To resolve the above-mentioned flow control of the network, the present invention provides a novel rate control scheme, Time-Division-Queue Rate Control Scheme (TDQ-RCS). The TDQ-RCS according to the present invention can rapidly determine the departure time of the arrival packet, add this arrival packet into the time division queue to which it belongs according to its departure time, and then output the packet on schedule. Moreover, all algorithms employed by this TDQ-RCS can be completed in a constant time since these algorithms are simple for the arrival packets of different sizes. Especially, the TDQ-RCS neither generates any dummy packet nor wastes any bandwidth but still can accomplish the bandwidth management. Therefore, by using the inventive TDQ-RCS, the present invention can obtain the following benefits easily:

(1) Management of network resources;

(2) Management of bi-directional bandwidth;

(3) Guarantee of bandwidth for applications/services/customers/stations;

(4) Control of traffic stream without generating any dummy packet; and

(5) Friendly rate limitation of QoS control manner.

Therefore, one advantage of the present invention is to provide a method and device for significantly managing the bandwidth of a data communication network without generating any dummy packet and wasting the bandwidth based on the TDQ-RCS according to the present invention.

Another advantage of the present invention is to provide a method and device for significantly managing the bandwidth of a data communication network, over which unbalanced bi-directional TCP traffic streams are transmitted, without generating any dummy packet and wasting the bandwidth based on the TDQ-RCS using Maximum Segment Size (MSS) header according to the present invention.

### BRIEF DESCRIPTION OF THE DRAWINGS

Other aspects and advantages of the invention will become apparent from the following descriptions taken in conjunction with the accompanying drawings, wherein:

FIG. 1 shows a simplified schematic block diagram of an ideal time division queue rate control scheme (TDQ-RCS) according to one embodiment of the present invention;

FIG. 2(a) shows a flow chart of an input packet of the ideal TDQ-RCS of FIG. 1;

FIG. 2(b) shows a flow chart of a schedule indicator of the ideal TDQ-RCS of FIG. 1;

FIG. 3 shows a simplified schematic diagram of an approximately ideal TDQ-RCS according to another embodiment of the present invention;

FIG. 4(a) shows a flow chart of an input packet of the approximately ideal TDQ-RCS of FIG. 3;

FIG. 4(b) shows a flow chart of a schedule indicator of the approximately ideal TDQ-RCS of FIG. 3.

FIG. 5(a) shows a schematic diagram of MSS in SYN segment; and

FIG. 5(b) shows a flow chart of approximation TDQ-RCS with MSS.

### DETAILED DESCRIPTION OF THE PREFERRED EMBODIMENT

The present invention now will be described more clearly with reference to the accompanying drawings, in which embodiments of the invention are shown. Although one of the embodiments illustrated relates to a CMOS image sensor application, those skilled in the art will appreciate that this invention may be embodied in many different forms set forth herein. These embodiments are provided so that this disclosure will be thorough and complete, and will fully convey the scope of the invention to those skilled in the art.

Reference now will be made in detail to the preferred embodiments of the present invention as illustrated in the accompanying drawings in which like reference numerals designate like or corresponding elements throughout the drawings.

### BANDWIDTH MANAGEMENT SCHEME

A bandwidth management device for use in the network according to the present invention controls the bandwidth of each incoming traffic stream of the bandwidth management device, such as a QoS router, based on the predefined Policy-Based QoS Rules. The bandwidth management scheme according to an embodiment of the present invention is the so-called TDQ-RCS. This TDQ-RCS scheme of the present invention can rapidly determine the departure time of the packet arriving at the network equipment and transmit the arrival packet out of the bandwidth management device, such as a QoS router, on schedule by adding the arrival packet into its corresponding time division queue according to its departure time. Moreover, all algorithms of this scheme can be completed in a constant time. Most importantly, the TDQ-RCS neither generates any dummy packet nor wastes any bandwidth but still accomplish the bandwidth management of the bandwidth management device. Therefore, by using TDQ-RCS, we can gain the following benefits easily: (1) management of network resources, (2) bidirectional bandwidth management, (3) guaranteed bandwidth for applications/services/customers/stations, and (4) controlled traffic stream without generating any dummy packet.

### TIME-DIVISION-QUEUE RATE CONTROL SCHEME

To simplify the process of the TDQ-RCS, just like the currently available bandwidth management systems, rate control is always conducted with knowledge of QoS (Quality of Service) information of input packets. That is, the relevant QoS information always has been attached to the input packet before a rate control module of the bandwidth management device commences the process of the input packets. As well known by persons skilled in the art, a flow classification module (not shown) is usually provided at the input terminal of the bandwidth management device. The flow classification module is to recognize the flow information, such as maximum rate, minimum rate, committed rate and so on, of input packets flowing into the bandwidth management device. Furthermore, several rate control rules are set up in the flow classification module. The QoS information of the input packets can be derived directly or indirectly from the flow information. Details of the flow classification module can be found in ROC (Taiwan) patent application No. 88121943 and its corresponding U.S. application Ser. No. 09/498,096.

Furthermore, in order to simplify the analysis of the bandwidth management issue, the present invention first copes with only unidirectional traffic streams to be managed in the TDQ-RCS. Then, the present invention can deal with very well by just applying two sets of TDQ-RCS to control the traffic streams in two different directions so as to achieve the bi-directional bandwidth management.

To realize the TDQ-RCS of the present invention, time domain is partitioned into infinite time slots. Each time slot is of constant interval and contains one queue, which stores the information relevant to the packets that have to be sent out at this time slot on schedule.

### IDEAL TDQ-RCS

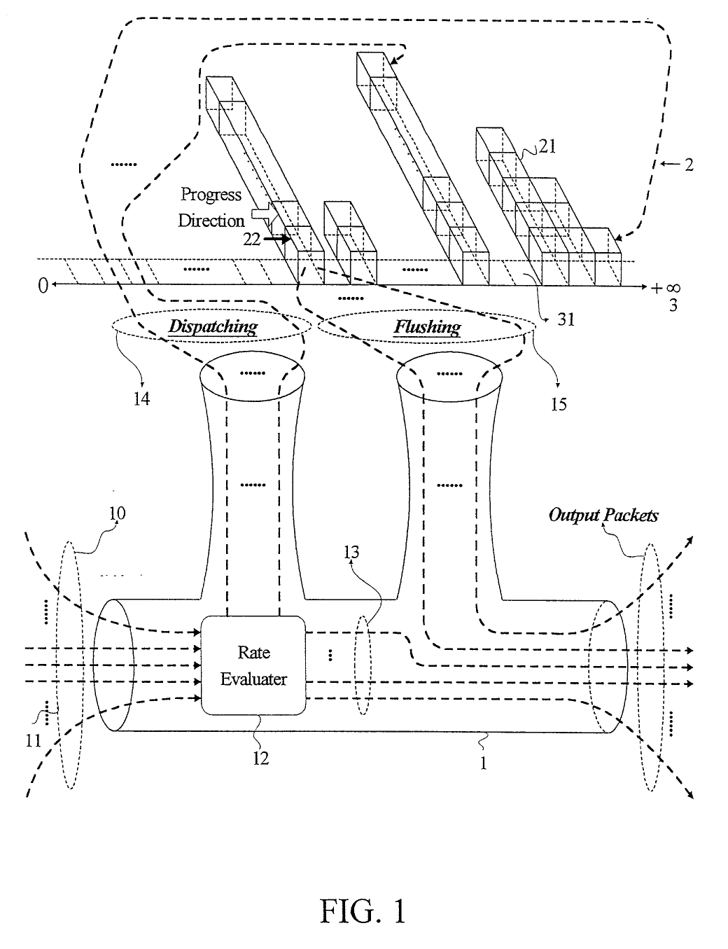

FIG. 1 shows the architecture of an ideal TDQ-RCS according to the present invention. First of all, it is defined in the TDQ-RCS for the sake of simple analysis that time domain 3 is partitioned into infinite time slots 31 of constant interval, for example 1 ms, and a memory 2 of the bandwidth management device 1 contains a plurality of memory cells corresponding to queues 21. Each queue 21 corresponds to each time slot and thus called a time division queue (TDQ) 21. Each TDQ 21 stores information related to the input packets 10 to be sent out of the bandwidth management device 1 at the corresponding time slot on schedule. In fact, it is difficult to have infinite time slots as implementing the TDQ-RCS unless the memory 2 is extremely huge. Thus, it will be discussed the approximation of the ideal TDQ-RCS below. Furthermore, in order to improve the TDQ-RCS in the way of processing TCP traffic streams, the concept of setting Maximum Segment Size (MSS) [see reference 12 of the appendix for details] is applied to the TDQ-RCS.

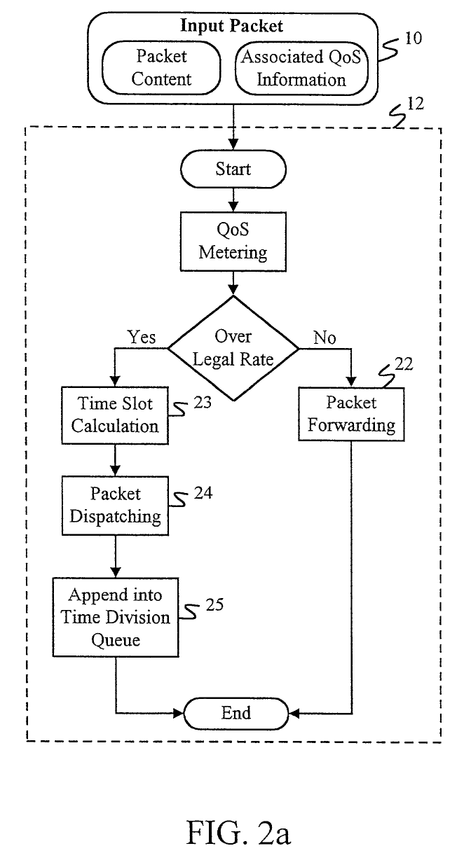

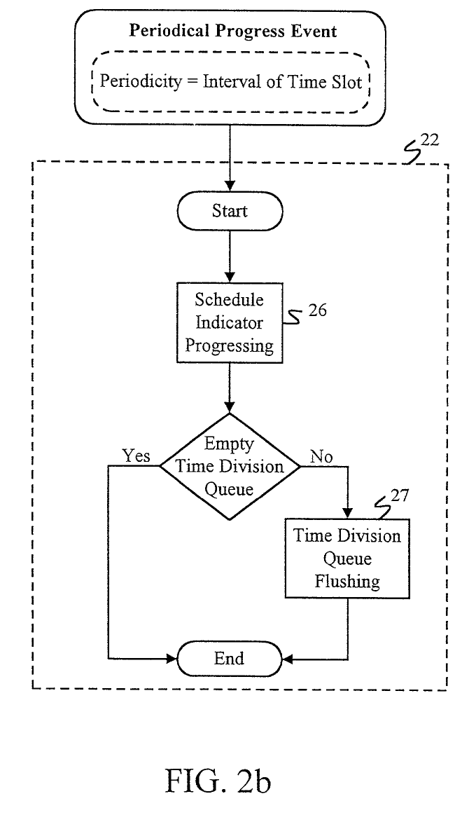

Referring to FIG. 2(a), an input packet 10, which includes packet contents and associated QoS information, is input, via a channel 11, into a rate evaluator 12 of the bandwidth management device 1. A QoS metering module (not shown) in the rate evaluator 12 then determines how to process the input packets 10 based on the QoS information of the input packet 10 (step 21). If the rate of the input packet 10 does not exceed the legal rate predetermined by the flow classification module for the input packet 10 as a non-over rate packet 13 does (the right branch of FIG. 2(a)), the rate evaluator 12 will directly send the input packet 10 out of the bandwidth management device 1 (step 22). The legal rate predetermined for the input packet 10 is set in the flow rules of the flow classification module. Otherwise, the rate evaluator 12 takes the input packets 10 for an over rate packet 14, and calculates, based on the QoS information of the over rate packet 14, which time slots the over rate packets 14 should be assigned to according to the following equations (1) and (2) (step 23).

POT=CST+PÕT (1)

$$TSID = ⌊ \frac{POT}{TSIS} + \frac{TSIS}{2} ⌋ \qquad ( 2 )$$

where:

CST (Current System Time) denotes the current time of the bandwidth management device 1;

PQT (Packet Queuing Time) denotes the time that the input packet 10 should be queued by TDQ-RCS determined by the QoS metering module for rate controlling;

POT (Packet Output Time) denotes the time that the input packet 10 should be transmitted out;

TSIS (Time Slot Interval Size) denotes the interval size of each time slot; and

TSID (Time Slot ID) denotes the time slot number that the input packet 10 belongs to.

After that, the rate evaluator 12 will dispatch (step 24) and append the over rate packet 14 into the time division queue 21 of the calculated time slot (step 25).

As shown in FIG. 1, a schedule indicator 22 is provided in the memory 2 to indicate which time slot the input packets 10 should be flushed out. Referring to FIG. 2(b), the schedule indicator 22 periodically progresses to the next time slot in time domain, and the period is equal to the interval of the time slot 31 such that the time slot that the schedule indicator 22 indicates can be always synchronous with the system time of the bandwidth management device 1. The progression action of the schedule indicator 22 can be formularized as Equation (3) (step 26).

TSID=PTSID+1 (3)

where:

PTSID (Previous Time Slot ID) denotes the latest on schedule time slot number; and

TSID (Time Slot ID) denotes the on schedule time slot number.

When the time slot that the schedule indicator 22 progresses to have a non-empty time division queue, the bandwidth management device 1 will flush all packets queued in the time division queue of this time slot. In this way, input packets 10 can be transmitted out of the bandwidth management device 1 on schedule. FIGS. 2(a) and 2(b) show a flow chart of the input packet 10 and the schedule indicator 22 of the ideal TDQ-RCS, respectively.

As shown in Eqs. (1) to (3), the calculations of all parameters are independent of the size of the input packet 10 and the flow No. (i.e., the place that this flow comes from), all algorithms of the ideal TDQ-RCS can be completed in a constant time, and the ideal TDQ-RCS can control the rate of any unidirectional traffic stream very well. However, it is not feasible to have infinite time slots when implementing the ideal TDQ-RCS. Thus, an approximation of the ideal TDQ-RCS will be proposed below.

### AN APPROXIMATION OF THE IDEAL TDQ-RCS

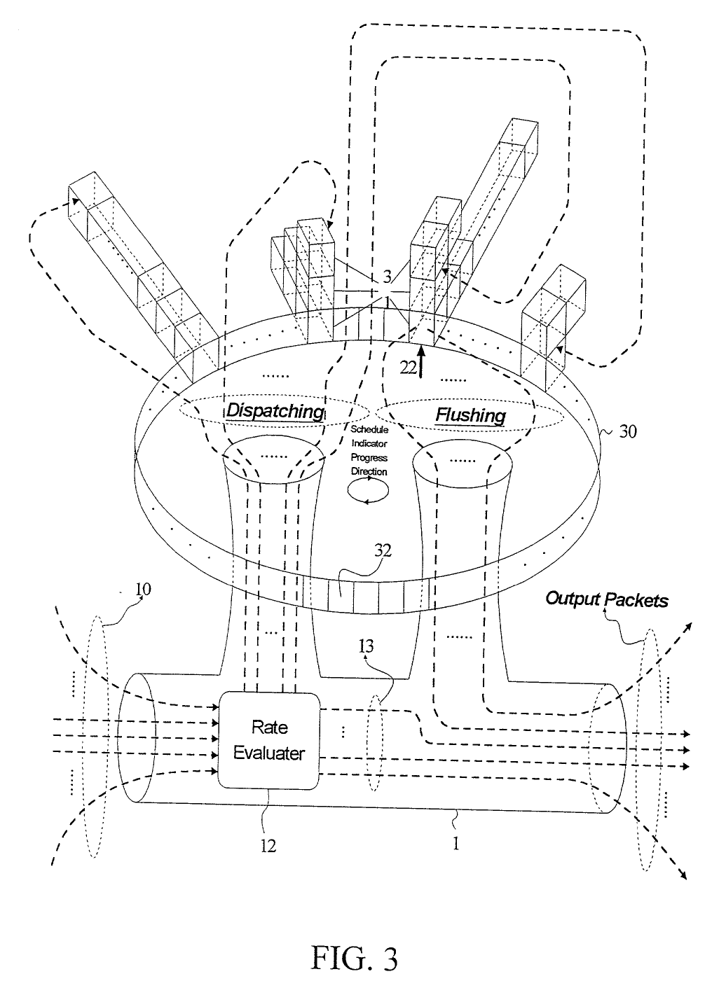

FIG. 3 shows the architecture of the approximation of the ideal TDQ-RCS according to the present invention, in which a “time ring” 30 is used to effectively imitate the function of infinite time slots 31 as shown in FIG. 1. The time ring 30 consists of finite time slot clusters 32, and each time slot cluster 32 is also of constant time interval, which is equal to the interval of time slot. As shown in FIG. 3, the time slot cluster 32 may contain one or multiple time slots. When implementing the time slot cluster 31 in the memory 2, all time slots 31 in the same time slot cluster 32 are always sorted in an ascending order based on their respective time slot IDs. Each time slot contains a time division queue, and an input packet is stored into a time division queue of a time slot according to its QoS information.

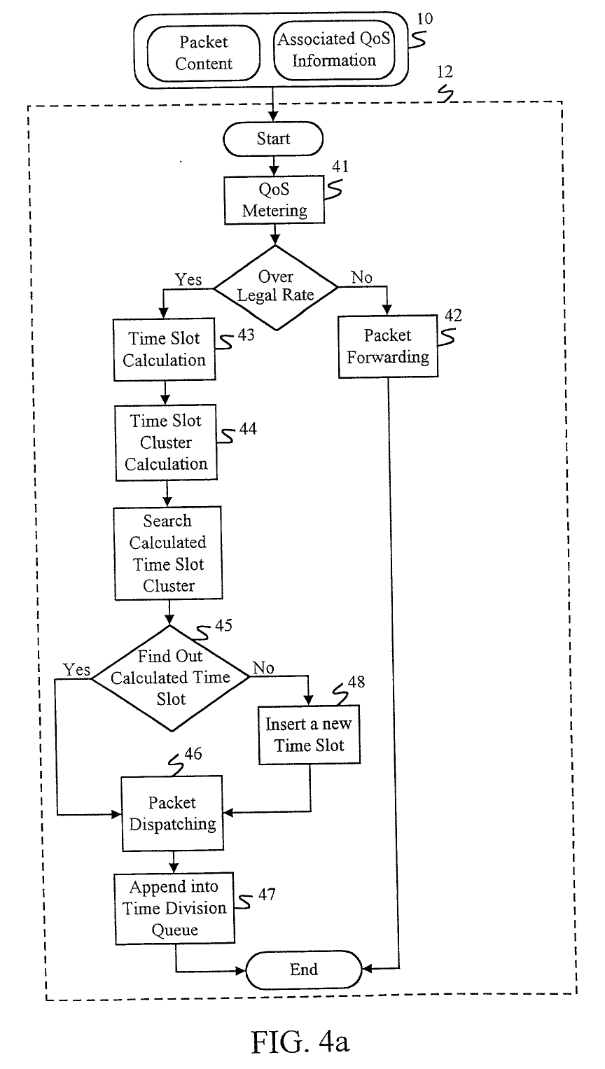

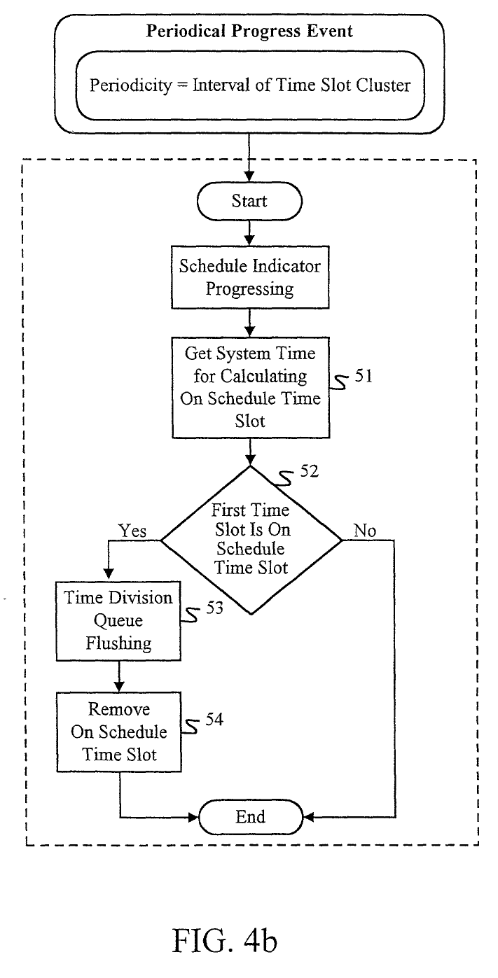

Refer to FIG. 4(a), which shows a flow chart of the input packet 10 of the approximation TDQ-RCS. All input packets 10 which contain packet contents and associated QoS information are still input into the rate evaluator 12 first, and the rate evaluator 12 will decide how to process the input packet 10 according to the QoS information of the input packet 10 (step 41). If the input packet 10 does not exceed its legal rate, the rate evaluator 12 will directly forward it (step 42). Otherwise, the rate evaluator 12 will calculate which time slot the input packet belongs to based on the QoS information of the input packet 10 according to Eqs. (1) to (3) (step 43). Then, the rate evaluator 12 further calculates which time slot cluster (TSCID) the calculated time slot (TSID) belongs to (step 44). If the calculated time slot cluster (TSCID) has already contained the time slot (TSID), which the input packet 10 belongs to (the left branch of step 45), the rate evaluator 12 will directly dispatch (step 46) and append the input packet 10 into the time division queue of the calculated time slot in the calculated time slot cluster (step 47). Otherwise, the rate evaluator 12 will insert a new time slot in the calculated time slot cluster (TSCID) and keep all time slots in an ascending order based on their IDs (step 48). Then, the rate evaluator 12 will dispatch and append the input packet into the time division queue of this new time slot in the calculated time slot cluster (step 47). Equations (4), (5), and (6) show the calculations of the time slot and the time slot cluster in the rate evaluator 12.

POT=CST+PÕT (4)

$$TSID = ⌊ \frac{POT}{TSIS} + \frac{TSIS}{2} ⌋ \qquad ( 5 )$$

TSCI=TSID mod TRS (6)

where

CST (Current System Time) denotes the current time of the bandwidth management device 1;

PQT (Packet Queuing Time) denotes the time that the input packet 10 should be queued by the approximation TDQ-RCS for rate controlling;

POT (Packet Output Time) denotes the time that the input packet should be transmitted out of the bandwidth management device 1;

TSIS (Time Slot Interval Size) denotes the interval size of each time slot 31;

TSID (Time Slot ID) denotes the time slot number that the input packet 10 belongs to;

TRS (Time Ring Size) denotes the number of time slot clusters in the time ring; and

TSCID (Time Slot Cluster ID) denotes the time slot cluster number that the calculated time slot belongs to.

For the approximation TDQ-RCS, the schedule indicator 22 is also used for the time ring 30. The schedule indicator 22 progresses to the next time slot cluster around the time ring 30 periodically, and the period is equal to the interval of the time slot cluster 32. Refer to FIG. 4(b), when the schedule indicator 22 progresses to a new time slot cluster, the system time of the bandwidth management device 1 is obtained (step 51) and used to calculate which time slot in this new time slot cluster should be processed at this time (step 52). So, the schedule indicator 22 can be always synchronous with the system time. Similarly, the progress action and the time slot calculation can be formularized as Equations (7) and (8), respectively. After calculating the time slot, the schedule indicator 22 will check whether the ID of the first time slot in this time slot cluster is equal to the ID of the calculated time slot. If affirmative, all packets queued in the time division queue of this time slot will be flushed (step 53) and this time slot is further removed (step 54). Therefore, packets can be transmitted out on schedule by using this scheme. For realizing the input packet and the schedule indicator processing flow of Approximation TDQ-RCS, please refer to FIGS. 4(a) and 4(b), respectively.

OSTSCID=(POSTSCID+1)mod TRS (7)

$$OSTSID = ⌊ \frac{CST}{TSIS} ⌋ \qquad ( 8 )$$

wherein:

TRS (Time Ring Size) denotes the number of time slot clusters in the time ring;

POSTSCID (Previous On Schedule Time Slot Cluster ID) denotes the last on schedule time slot cluster number;

OSTSCID (On Schedule Time Slot Cluster ID) denotes the on schedule time slot cluster number;

CST (Current System Time) denotes the current time of the system;

TSIS (Time Slot Interval Size) denotes the interval size of each time slot; and

OSTSID (On Schedule Time Slot ID) denotes the on schedule time slot number.

It is time consuming to do the calculation based on the above algorithms of the approximation of the ideal TDQ-RCS. That is, before dispatching the input packet 10 into the time slot 31, the rate evaluator 12 has to locate the time slot belonging to the input packet 10 in the calculated time slot cluster. Practically, such searching is not easy to be completed within a constant time. However, it is a feature in the network environment that a transmission traffic stream from any sender is limited. Practically, if the size of the time ring 30 is chosen to be large enough, the number of time slots 31 in any time slot cluster 32 will be bounded by a small number, and the searching can be substantially completed in a constant time.

Based on above, all algorithms of the approximation of the ideal TDQ-RCS can be completed in a reasonable constant time, and the approximation TDQ-RCS can function in real time and control the rate of any unidirectional traffic stream as good as the ideal TDQ-RCS since these algorithms are simple for the input packets of different sizes.

### APPROXIMATION TDQ-RCS WITH MSS

As mentioned above, the TDQ-RCS can control the rate of any unidirectional traffic stream very well. The simple way to achieve bi-directional bandwidth management is to use two sets of the TDQ-RCS in the bandwidth management device 1. However, in order to process a TCP (Transmission Control Protocol) traffic stream, the TDQ-RCS has to be enhanced to include the “Timeout” and “Acknowledgment” features of the TCP traffic streams. To facilitate the understanding of the effects of these two features on the TDQ-RCS of the present invention, the following situations should be taken into consideration:

(1) When the legal rate of a TCP traffic stream is very low, and a packet of a large size is transmitted from a terminal on the network through this TCP traffic stream, the packet of large size may be queued by the bandwidth management device 1 for a longer time, thus inevitably resulting in a TCP timeout event. In this case, this packet of a large size has to be retransmitted by the terminal.

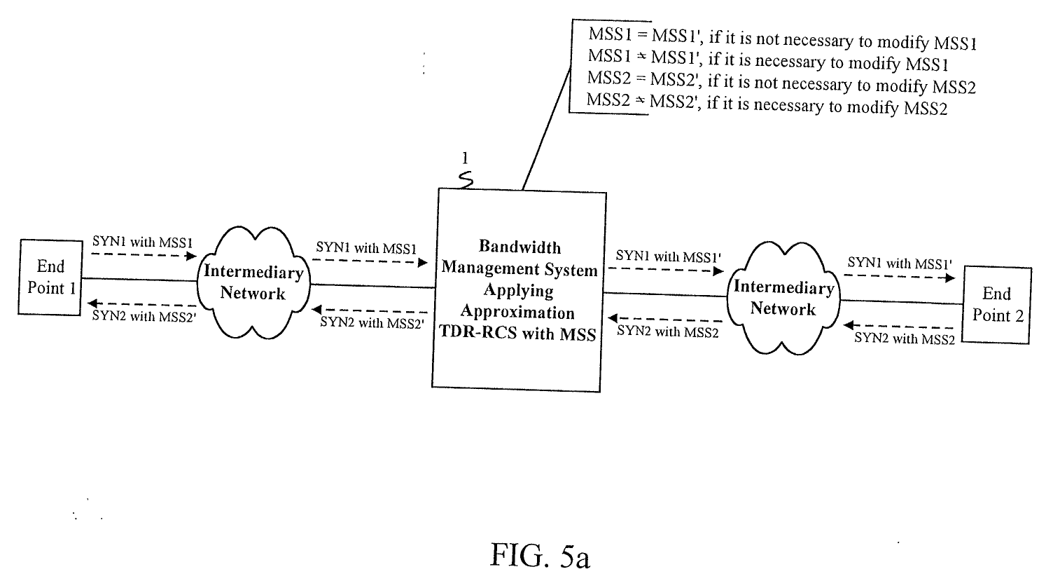

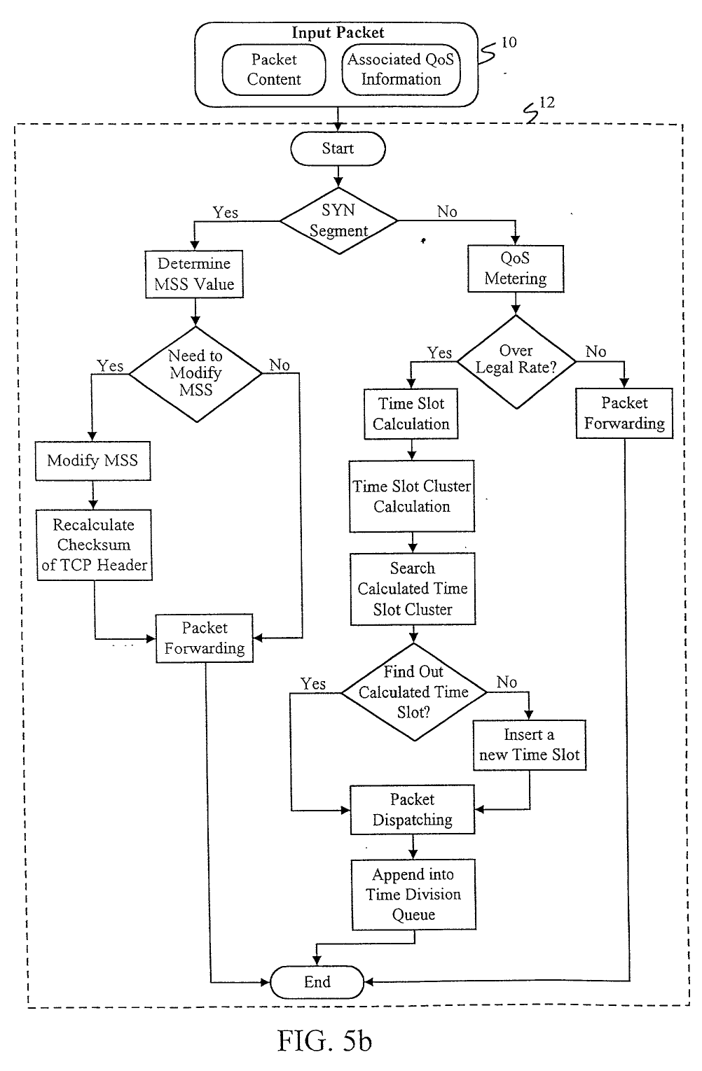

(2) When two traffic streams of extremely different rates are reserved in the same TCP connection in two different directions (for example, the rate in one direction is very low and the other is very high), and the packet sizes transmitted in these two directions are substantially the same. The acknowledgment signal forwarded in the low rate direction by, for example, the end point 1 receiving the data packet from the end point 2 in the high rate direction (see FIG. 5a), is always queued by the bandwidth management device 1 for a longer time. The TCP has a specific flow control mechanism. That is, the sender has to wait for the acknowledgment from the receiver for the prior transmitted packets before transmitting the next serial packets. Thus, an ideal rate cannot be achieved in the very high rate direction since that the acknowledgment signal which the sender waits for transmitted in the low rate direction is always queued by the bandwidth management device 1 for a longer time.

In order to resolve the above-identified situations, according to a preferred embodiment of the present invention, the queuing time of the packet coming from the sender in the low rate direction is reduced without varying the original QoS information. According to the present invention, a packet transmitted by the sender in the low rate direction will be partitioned into a series of smaller packets, if the payload size of the packet is larger than the legal rate predetermined for said traffic stream based on said QoS information. To achieve such partition, an optional header, Maximum Segment Size (MSS), of the TCP is employed in the present invention. The MSS is to set the largest payload size of the TCP traffic stream. Therefore, a packet transmitted by the sender in the low rate direction can be partitioned into a series of smaller packets by modifying the MSS of the TCP. As well known by persons skilled in the art, the MSS option will only appear in a synchronous segment (SYN) when a TCP connection is initially set up between two end points over the computer network. FIG. 5(a) shows the scheme of modifying the MSS that appears in the SYN segment. Referring to FIG. 5(a), when end point 1 intends to transceive data packets to/from end point 2, an initial synchronization process will be conducted between them in the SYN segment, in which MSS₁ in SYN₁ from the end point 1 indicates the largest payload size of the packet that the end point 1 can receive from the end point 2, and MSS₂ in SYN₂ from the end point 2 indicates the largest payload size of the packet that the end point 2 can receive from the end point 1. As shown in FIG. 5(a), the bandwidth management device 1 according to the present invention is located at the connection between intermediary network 1 (such as LAN) connected to the end point 1 and an intermediary network 2 (such as WAN) connected to the end point 2. When receiving the SYN₁ and SYN₂, the rate evaluator 12 of the bandwidth management device 1 will determine whether the MSS₁ of the packet coming from the end point 1 will cause the two situations mentioned above, and again whether the MSS₂ of the packet coming from the end point 2 will cause the two situations mentioned above. FIG. 5(b) shows a flow chart of the input packet 10 of the Approximation TDQ-RCS with MSS. From these two figures, we can clearly see that the bandwidth management scheme, Approximation TDQ-RCS with MSS, will determine MSS values of both sides according to their respective rates and modify the original MSS values if necessary. Besides, if the MSS has been modified, the checksum of TCP header has to be recalculated for the correctness. So, either side will never transmit a packet whose payload size is larger than its MSS in this TCP transaction.

Given the above, the basic idea of the TDQ-RCS has been explained, and an embodiment for implementing the TDQ-RCS in real world has been provided and an embodiment of optimizing the TDQ-RCS by modifying the MSS. According to the present invention, the following goals can be achieved easily:

(1) Management of network resources;

(2) Bi-Directional Bandwidth Management;

(3) Guarantee of bandwidth for applications/services/customers/stations; and

(4) Control of traffic stream without generating any dummy packet.

Although the invention has been disclosed in terms of preferred embodiments, the disclosure is not intended to limit the invention. The invention still can be modified or varied by persons skilled in the art without departing from the scope and spirit of the invention, which is determined by the claims below.

### APPENDIX: REFERENCES

[1] “Analysis and Simulation of a Fair Queuing Algorithm” by A. Demers, S. Keshav, and S. Shenker, SIGCOMM Symposium on communications Architectures and Protocols, September 1989.

[2] “A Generalized Processor Sharing Approach to Flow Control—The Single Node Case” by A. Parekh and R. G. Gallager, ACM/IEEE Transactions on Networking, Vol. 1 No. 3, pages 344-357, June 1993.

[3] “Implementing Scheduling Algorithms in High-Speed Networks” by D. C. Stephens, J. C. R. Bennett, and H. Zhang, IEEE Journal on Selected Areas in Communications, Vol. 17, No. 06, Pages 1145-1158, June 1999.

[4] “WF²Q: Worst-case Fair Weighted Fair Queuing” by J. C. R. Bennett and H. Zhang, Proc. IEEE INFOCOM'96, Pages 120-128, March 1996.

[5] “Why WFQ Is Not Good Enough for Integrated Services Networks” by J. C. R Bennett and H. Zhang, NOSSDAV'96, April 1996.

[6] “Generalized Processor Sharing Networks with Exponentially Bounded Burstiness Arrivals” by O. Yaron and M. Sidi, Journal of High Speed Networks, 3:375-387, 1994.

[7] U.S. Pat. No. 6,038,216, entitled “Method for Explicit Data Rate Control in a Packet Communication Environment without Data Rate Supervision” issued on Mar. 14, 2000 to Packeteer, Inc.

[8] U.S. Pat. No. 5,802,106, entitled “Method for Rapid Data Rate Detection in a Packet Communication Environment without Data Rate Supervision” issued on Sep. 1, 1998 to Packeteer, Inc.

[9] U.S. Pat. No. 6,018,516, entitled “Method for Minimizing Unneeded Retransmission of Packets in a Packet Communication Environment Supporting a Plurality of Data Link Rates” issued on Jan. 25, 2000 to Packeteer, Inc.

[10] U.S. Pat. No. 6,046,980 entitled “System for Manage Flow Bandwidth Utilization at Network, Transport and Application Layers in Store and Forward Network” issued on Apr. 4, 2000 to Packeteer, Inc.

[11] TCP/IP Illustrated Volume 1—The Protocols by W. Richard Stevens.

[12] “Rainbow Fair Queuing: Fair Bandwidth Sharing Without Per-Flow State” by Z. Cao, Z. Wang, and E. Zegura, INFOCOM'00, March 2000.

[13] “Statistical Analysis of Generalized Processor Sharing Scheduling Discipline” by Z. L. Zhang, D. Towsley, and J. Kurose, Proc. ACM SIGCOMM'94, Pages 68-77, August 1994.

1. In a bandwidth management device for use in a data communication network, a method of controlling an input packet for managing a rate of any traffic stream corresponding to said input packets, said bandwidth management device having a memory, which comprises a plurality of cells as time-division queues, each queue corresponding to a time slot of a constant interval in time domain, said method comprising the steps of:
(a) retrieving quality of service (QoS) information of said traffic stream from said input packet;
(b) determining whether the rate of said input packet exceeds a legal rate predetermined for said traffic stream based on said QoS information;
(c) if the rate of said input packet exceeds the predetermined legal rate, dispatching said input packet into a time-division queue; and
(d) transmitting said input packet queued in said time-division queue out of said bandwidth management device when the corresponding time of said time-division queue is equal to the system time of said bandwidth management device.

2. The method as set forth in claim 1, wherein step (c) further comprises the steps of:
(c1) if the rate of said input packet exceeds the predetermined legal rate, determining the time slot which said input packet belongs to, based on the QoS information of said input packet, wherein said determined time slot corresponds to said time-division queue of step (d).

3. The method as set forth in claim 2, wherein the plurality of time slots are sequentially arranged in a time ring having a period (Time Ring Size, TRS), said time ring consists of a plurality of time slot clusters of a constant interval, and each time slot cluster comprises one or more time slots, and wherein step (c) further comprises the steps of:
(c2) determining a time slot cluster to which said determined time slot belongs;
(c3) if said determined time slot cluster contains the time slot which said input packet belongs to, appending said input packet into a time division queue of said determined time slot in said determined time slot cluster; and
(c4) if said determined time slot cluster does not contain the time slot which said input packet belongs to, adding a new time slot to said determined time slot cluster and appending said input packet into the time division queue of said determined time slot in said determined time slot cluster.

4. The method as set forth in claim 1, said method further comprising: after step (b), if the rate of said input packet does not exceed the predetermined legal rate, directly transmitting said input packet out of said bandwidth management device.

5. A bandwidth management device for use in a data communication network, said bandwidth management device comprising:
a flow classification module for retrieving quality of service (QoS) information from said input packet; and determining whether the rate of said input packet does not exceed the legal rate predetermined for said traffic stream based on said QoS information;
a memory comprising a plurality of cells as time division queues, each queue corresponding to a time slot of constant interval in the time domain;
a rate evaluator for dispatching said input packet into a time division queue if the rate of said input packet exceeds the predetermined legal rate, and transmitting said input packet queued in said time division queue out of said bandwidth management device when the corresponding time of said time division queue is equal to the system time of said bandwidth management device.

6. The bandwidth management device as set forth in claim 5, wherein said rate evaluator further determines the time slot which said input packet belongs to, based on the QoS information of said input packet, if the rate of said input packet exceeds the predetermined legal rate, and wherein said determined time slot corresponds to said time division queue of step (d).

7. The bandwidth management device as set forth in claim 5, wherein the plurality of time slots are sequentially arranged in a time ring having a period, said time ring consists of a plurality of time slot clusters of a constant interval and each time slot cluster comprises one or more time slots, and wherein said rate evaluator determines the time slot cluster which said determined time slot belongs to; appends said input packet into the time division queue of said determined time slot in said determined time slot cluster if said determined time slot cluster contains the time slot which said data packet belongs to; adds a new time slot to said determined time slot cluster and appends said input packet into the time division queue of said determined time slot in said determined time slot cluster if said determined time slot cluster does not contain the time slot which said input packet belongs to.

8. The bandwidth management device as set forth in claim 5, said rate evaluator directly transmits said input packet out of said bandwidth management device if the rate of said input packet does not exceed the predetermined legal rate.

9. In a bandwidth management device for use in a data communication network, a method for controlling the rates of any bi-directional traffic stream between any two terminals over said data communication network, said bandwidth management device having a memory, which comprises a plurality of cells as time division queues, each queue corresponding to a time slot of a constant interval in a time domain, said method comprising the steps of:
(a) detecting synchronous segments during said two terminals initially set up a connection therebetween;
(b) retrieving maximum segment size (MSS) option headers transmitted between said two terminals in said synchronous segments, wherein said MSS option header transmitting from one terminal designates a payload of said input packet coming from the other terminal;
(c) retrieving quality of service (QoS) information from said input packets;
(d) modifying said MSS option header transmitting from one terminal based on the rate contained in the QoS information of said one terminal so as to reduce the largest payload of said input packet, if the payload determined by said MSS header will cause said bandwidth management device cannot control the rates of said bi-directional traffic stream; and recalculating a checksum of a TCP header of said input packet with said MSS option header, if said MSS option header has been modified;
(e) determining whether the rate of said input packet, no matter whose payload is reduced or not, exceeds a legal rate predetermined for said input packet based on said QoS information;
(f) if the rate of said input packet exceeds the predetermined legal rate, dispatching said input packet into a time division queue; and
(g) transmitting said input packet queued in said time division queue out of said bandwidth management device when the corresponding time of said time division queue is equal to the system time of said bandwidth management device.

10. The method as set forth in claim 9, wherein step (e) further comprises the steps of:
(e1) if the rate of said input packet exceeds the predetermined legal rate, determining the time slot which said input packet belongs to, based on the QoS information of said input packet, wherein said determined time slot corresponds to said time division queue of step (f).

11. The method as set forth in claim 10, wherein the plurality of time slots are sequentially arranged in a time ring having a period (TRS), said time ring consists of a plurality of time slot clusters of a constant interval and each time slot cluster comprises one or more time slots, and wherein step (e1) further comprises the steps of:
(e2) determining the time slot cluster to which said determined time slot belongs;
(e3) if said determined time slot cluster contains the time slot which said input packet belongs to, appending said input packet into the time division queue of said determined time slot in said determined time slot cluster; and
(e4) if said determined time slot cluster does not contain the time slot which said input packet belongs to, adding a new time slot to said determined time slot cluster and appending said input packet into the time division queue of said determined time slot in said determined time slot cluster.

12. The method as set forth in claim 9, further comprising: after step (e), if the rate of said input packet does not exceed the predetermined legal rate, directly transmitting said input packet out of said bandwidth management device.
